(19) United States
(12) Patent Application Publication
(10) Pub. No.: US 2024/0301164 A1
(43) Pub. Date: Sep. 12, 2024

(54) POLARIZING PLATE AND OPTICAL DISPLAY APPARATUS

(71) Applicant: SAMSUNG SDI CO., LTD., Yongin-si (KR)

(72) Inventors: Min Jeong PARK, Suwon-si (KR); Yoo Jin KIM, Suwon-si (KR); Ji Hyun WI, Suwon-si (KR); Han Su KIM, Suwon-si (KR); Eun Mi KIM, Suwon-si (KR); A Ra JO, Suwon-si (KR)

(21) Appl. No.: 18/593,462

(22) Filed: Mar. 1, 2024

(30) Foreign Application Priority Data
Mar. 8, 2023 (KR) 10-2023-0030402

(51) Int. Cl. C08K 3/30; C08K 3/16; C08K 3/38; G02B 5/30

(52) U.S. Cl. CPC C08K 3/30; C08K 3/16; C08K 3/38; G02B 5/3025; C08K 2003/3045

(57) ABSTRACT

A polarizing plate and an optical display apparatus including the same are disclosed. A polarizing plate includes: a polarizer; and a protective layer on at least one surface of the polarizer, and the polarizer includes a polyvinyl alcohol based film containing a dichroic material and contains a zinc cation and a sodium cation, and a ratio of the sodium cation to the zinc cation is in a range from 0.1 to 0.96, and a total content of the zinc cation and the sodium cation is in a range from 500 ppm to 1,500 ppm.

### CROSS-REFERENCE TO RELATED APPLICATION

The present application claims priority to and the benefit of Korean Patent Application No. 10-2023-0030402, filed on Mar. 8, 2023 in the Korean Intellectual Property Office, the entire disclosure of which is incorporated herein by reference.

### BACKGROUND

### 1. Field

Aspects of embodiments of the present invention relate to a polarizing plate and an optical display apparatus including the same.

### 2. Description of the Related Art

Polarizing plates are commonly used in light emitting displays or liquid crystal displays. Such a polarizing plate essentially includes a polarizer providing a polarization function. The polarization function may be realized by a dichroic material containing an iodine-based material, dichroic dyes, and the like.

The polarizing plate is generally required to have high reliability after being left at high temperature for a long period of time. In particular, the polarizing plate is required to have small variations in color value as, color value bs, polarization degree, and light transmittance after being left at high temperature for a long period of time.

The background technique of the present invention is disclosed in Korean Patent Laid-open Publication No. 2020-0115071. According to this publication, a discoloration suppression layer, for example, an anti-reddening layer, may be formed on a polarizer to prevent reddening of the polarizing plate.

### SUMMARY

According to an aspect of embodiments of the present invention, a polarizing plate that includes a polarizer having high reliability at high temperature while containing a trace amount of metal cations is provided.

According to another aspect of embodiments of the present invention, a polarizing plate that has high reliability at high temperature due to no yellowing and small variations in color value as, color value bs, polarization degree, and light transmittance, after being left at high temperature, is provided.

According to another aspect of embodiments of the present invention, a polarizing plate that can prevent (prevent or substantially prevent) deposition of at least one of zinc and sodium is provided.

According to another aspect of embodiments of the present invention, a polarizing plate that has high reliability at high temperature with a typical protective film for polarizers alone is provided.

According to an aspect of one or more embodiments of the present invention, a polarizing plate is provided.

According to one or more embodiments, a polarizing plate includes: a polarizer; and a protective layer on at least one surface of the polarizer, wherein the polarizer includes a polyvinyl alcohol based film containing a dichroic material and contains a zinc cation and a sodium cation, and wherein a ratio of the sodium cation to the zinc cation is in a range from 0.1 to 0.96, and a total content of the zinc cation and the sodium cation is in a range from 500 ppm to 1,500 ppm.

According to an aspect of one or more embodiments of the present invention, an optical display apparatus is provided.

According to one or more embodiments, an optical display apparatus includes the polarizing plate according to an embodiment of the present invention.

Embodiments of the present invention provide a polarizing plate that includes a polarizer having high reliability at high temperature while containing a trace amount of metal cations.

Further, embodiments of the present invention provide a polarizing plate that has high reliability at high temperature due to no yellowing and small variations in color value as, color value bs, polarization degree, and light transmittance after being left at high temperature.

Further, embodiments of the present invention provide a polarizing plate that can prevent (prevent or substantially prevent) deposition of at least one of zinc and sodium.

Further, embodiments of the present invention provide a polarizing plate that has high reliability at high temperature with a typical protective film for polarizers alone.

### DETAILED DESCRIPTION OF THE DRAWINGS

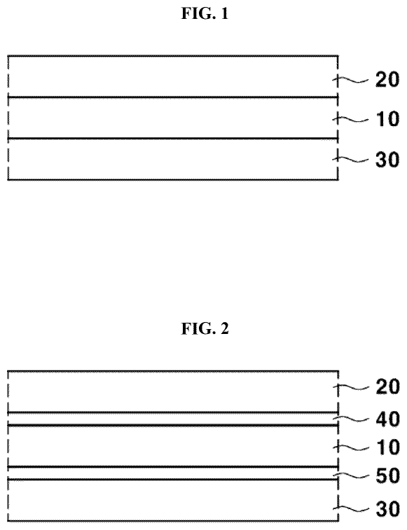

FIG. 1 is a cross-sectional view of a polarizing plate according to an embodiment of the present invention.

FIG. 2 is a cross-sectional view of a polarizing plate according to another embodiment of the present invention.

### DETAILED DESCRIPTION

Herein, some example embodiments of the present invention will be described in further detail with reference to the accompanying drawings such that the present invention can be implemented by those skilled in the art. However, it is to be understood that the present invention may be embodied in different ways and is not limited to the following embodiments.

The terminology used herein is for the purpose of describing example embodiments and is not intended to limit the present invention. As used herein, the singular forms “a,” “an,” and “the” are intended to include the plural forms as well, unless the context clearly indicates otherwise.

As used herein to represent a specific numerical range, “X to Y” means a value greater than or equal to X and less than or equal to Y.

Herein, “(meth)acrylic” may refer to acrylic and/or methacrylic.

Herein, the content of a cation in a polarizer, such as a zinc cation (for example, Zn²⁺), a sodium cation (for example, Na⁺), a potassium cation (for example, K⁺), and a boron cation (for example, B³⁺), may be measured by the following method:

### [Method for Measurement of Cation Content of Polarizer]

The content of a cation in a polarizer may be measured by inductively coupled plasma-optical emission spectrometry (ICP-OES).

Herein, “color value as” and “color value bs” of a polarizing plate are converted L*a*b values measured at a wavelength of 380 nm to 780 nm, where “L”, “a*”, and “b*” refer to color values in accordance with CIE 1976 standards. The “color value as” and the “color value bs” may be measured using a spectrophotometer (V-7100, Jasco Corp.), without being limited thereto.

Herein, “polarization degree (PE)” of a polarizing plate is a value measured at a wavelength of 380 to 780 nm.

Herein, “light transmittance (Ts)” of a polarizing plate is an average light transmittance measured at a wavelength of 380 nm and 780 nm and refers to “total luminous transmittance.”

Herein, “zinc cation” refers to a cation derived from zinc and may be, for example, Zn²⁺. Herein, “sodium cation” refers to a cation derived from sodium and may be, for example, Nat. Herein, “potassium cation” refers to a cation derived from potassium and may be, for example, K⁺. Herein, “boron cation” refers to a cation derived from boron and may be, for example, B³⁺.

The present invention provides a polarizing plate that includes a polarizer having high reliability at high temperature while containing a trace amount of metal cations. Since the polarizer contains a trace amount of metal cations, it is possible to prevent (prevent or substantially prevent) a metal as a metal cation source, such as at least one of zinc and sodium, from depositing from the polarizer. The polarizing plate according to the invention has high reliability at high temperature due to no yellowing and small variations in color value as, color value bs, polarization degree, and light transmittance after being left at high temperature. The polarizing plate according to the present invention has high reliability at high temperatures with a typical protective film for polarizers alone.

The polarizing plate according to the present invention includes a polarizer and a protective layer formed on at least one surface of the polarizer, wherein the polarizer includes a polyvinyl alcohol based film containing a dichroic material and contains a zinc cation and a sodium cation, a ratio of the sodium cation to the zinc cation is in a range from 0.1 to 0.96, and a total content of the zinc cation and the sodium cation is in a range from 500 ppm to 1,500 ppm.

The polarizing plate according to the present invention includes a polarizer and a protective layer formed on at least one surface of the polarizer. As the polarizing plate includes the polarizer described below, which has high reliability at high temperature while containing a trace amount of metal cations, the polarizing plate has no yellowing and small variations in color value as, color value bs, polarization degree, and light transmittance after being left at high temperature, and has high reliability at high temperature with a typical protective film for polarizers alone.

In an embodiment, a total content of metal cations in the polarizer may be 20,000 ppm or less, for example, 1,000 ppm to 10,000 ppm, or 3,000 ppm to 8,000 ppm. Within this range, the metal cations in the polarizer can be prevented or substantially prevented from affecting polarization by the polarizer and realization of a high-quality screen due to a low content thereof. Herein, the “metal cations” may refer to all cations derived from an alkali metal, an alkaline earth metal, a transition metal, and a post-transition metal, respectively.

In an embodiment, the polarizing plate may have a variation in color value as of 1.5 or less, for example, 1.2 or less, or, for example, 0.9 to 1.2, as calculated according to the following Equation 1, and a variation in color value bs of 4 or less, for example, 3.6 or less, or, for example, 2.5 to 3.6, as calculated according to the following Equation 2. Within this range, the polarizing plate can have high reliability at high temperature.

$$Variation in color value as = \vert asll - asl \vert , \qquad Equation 1$$

where asl is an initial color value as of the polarizing plate, and asll is a color value as of the polarizing plate, as measured after the polarizing plate is left at 105° C. for 500 hours.

$$Variation in color value bs = \vert bsll - bsl \vert , \qquad Equation 2$$

where bsl is an initial color value bs of the polarizing plate, and ball is a color value bs of the polarizing plate, as measured after the polarizing plate is left at 105° C. for 500 hours.

In an embodiment, the polarizing plate may have a polarization degree variation of 0.05% or less, for example, 0% to 0.05% or 0.01% to 0.04%, as calculated according to the following Equation 3. Within this range, the polarizing plate can have high reliability at high temperature and can realize a high-quality screen even after being left at high temperature for a long period of time.

$$polorization degree variation = \vert Pll - Pl \vert , \qquad Equation 3$$

where PI is an initial polarization degree (unit: %) of the polarizing plate, and Pll is a polarization degree (unit: %) of the polarizing plate, as measured after the polarizing plate is left at 105° C. for 500 hours.

In an embodiment, the polarizing plate may have a light transmittance variation of 0.5% or less, for example, 0% to 0.5% or 0.3% to 0.4%, as calculated according to the following Equation 4. Within this range, the polarizing plate can have high reliability at high temperature and can realize a high-quality screen even after being left at high temperature for a long period of time.

$$Light transmittance variation = \vert Tll - Tl \vert , \qquad Equation 4$$

where TI is an initial light transmittance (unit: %) of the polarizing plate, and TII is a light transmittance (unit: %) of the polarizing plate, as measured after the polarizing plate is left at 105° C. for 500 hours.

The variations in color value as, color value bs, polarization degree, and light transmittance change mainly depend on the polarizer and are substantially independent of the protective layer.

In the following, the polarizer will be described first.

The polarizer is a linear light-absorbing polarizer and has a function of polarizing incident light by transmitting only a light component incident from one direction and absorbing a light component incident from a direction perpendicular to the direction.

In an embodiment, the polarizer includes a polyvinyl alcohol (PVA) based film. Here, the polyvinyl alcohol based film may include not only a polyvinyl alcohol based resin but also a resin of a polyvinyl alcohol based derivative. For example, the polarizer may be a polarizer including a polyvinyl alcohol based film that includes a polyvinyl alcohol based derivative resin or is composed of the polyvinyl alcohol based derivative resin alone.

In an embodiment, the polyvinyl alcohol based derivative contains hydrophilic and hydrophobic functional groups. The hydrophobic functional group is present in addition to a hydroxyl (OH) group present as the hydrophilic functional group in polyvinyl alcohol. The hydrophobic functional group may be present in a main chain and/or a side chain of the polyvinyl alcohol based derivative resin. The “main chain” refers to a part forming a backbone of the polyvinyl alcohol derivative and the “side chain” refers to a part branching off of the backbone. In an embodiment, the hydrophobic functional group is present in the main chain of the polyvinyl alcohol derivative.

The polyvinyl alcohol based derivative containing the hydrophilic and hydrophobic functional groups may be prepared by polymerization of at least one vinyl ester based monomer, such as vinyl acetate, vinyl formate, vinyl propionate, vinyl butyrate, vinyl pivalate, and isopropenyl acetate, with a monomer providing a hydrophobic functional group. In an embodiment, the vinyl ester based monomer includes vinyl acetate. The monomer providing a hydrophobic functional group may include a monomer providing a hydrocarbon repeat unit, such as ethylene and propylene.

In an embodiment, the polyvinyl alcohol based film may have a softening point of 66° C. to 70° C., for example, 67° C. to 69° C. Within this range, the polyvinyl alcohol based film does not suffer from melting and fracture when stretched and can easily form the polarizer according to the present invention.

In an embodiment, the polyvinyl alcohol based film may have a tensile strength of 95 MPa to 105 MPa, and, in an embodiment, 97 MPa to 99 MPa, as measured in a machine direction thereof. Within this range, the polyvinyl alcohol based film does not suffer from melting and fracture when stretched, can increase the degree of polarization through effective alignment of polyvinyl alcohol molecule chains, and can easily form the polarizer according to the present invention. Tensile strength of the polyvinyl alcohol based film may be measured at 25° C. using a universal testing machine (UTM) in accordance with ASTM D882.

The polyvinyl alcohol based film may have a thickness of 50 μm or less, for example, 10 μm to 50 μm. Within this range, the polyvinyl alcohol based film does not suffer from melting and fracture when stretched.

The polyvinyl alcohol based film may be a TS-#4500 PVA film (Kuraray Co., Ltd.), without being limited thereto.

The polarizer contains a dichroic material. In an embodiment, the polarizer may be dyed with the dichroic material. The dichroic material may include an iodine-based material, or may include a dichroic dye, such as an azo dye, as a non-iodine-based material. In general, polarizers may be classified into an iodine-based polarizer that contains an iodine-based material and a dye-based polarizer that contains a dichroic dye. Although this is not necessarily the case, as compared to the dye-based polarizer, the iodine-based polarizer easily decomposes under high temperature conditions and/or under high temperature/humidity conditions, thereby generating 12, which can cause discoloration due to unwanted light absorption in the visible spectrum.

As the polarizer contains a trace amount of metal cations, especially a zinc cation and a sodium cation, the polarizing plate according to the present invention does not suffer from deposition of zinc and sodium after manufacture of the polarizer, has high reliability in terms of variations in polarization degree and light transmittance after being left at high temperature for a long period of time, has high reliability at high temperature due to small variations in both color value as and color value bs after being left at high temperature for a long period of time, and secures high reliability at high temperature simply by disposing a typical protective film for polarizers on the polarizer without requiring an additional discoloration suppression layer and the like.

In an embodiment, the polarizer contains a zinc cation and a sodium cation, and a ratio of the sodium cation to the zinc cation is in a range from 0.1 to 0.96, and a total content of the zinc cation and the sodium cation is in a range from 500 ppm to 1,500 ppm.

Herein, the “ratio” is a value calculated based on the contents (weights) of the zinc cation and the sodium cation in the polarizer, as measured by the method described above.

In the present invention, in addition to a zinc cation commonly added to increase reliability of the polarizer at high temperature and/or under high temperature/humidity conditions and a potassium cation commonly used in dyeing, stretching, crosslinking, and/or color correction in a polarizer manufacturing process, the polarizer further contains a sodium cation, wherein the ratio of the sodium cation to the zinc cation and the total content of the zinc cation and the sodium cation are adjusted within the ranges set forth above.

When the polarizer is heated to high temperatures, the sodium cation is thought to be able to be bound between I³⁻ or I⁵⁻ in the polarizer to form a stable chelating compound, thereby inhibiting transformation of I⁵⁻ or I³⁻ to I³⁻ or I⁻, or to be able to form a stable compound with a polyvinyl alcohol-based material or form an ionic bond with boric acid, thereby improving durability, without being limited thereto.

If the ratio of the sodium cation to the zinc cation is less than 0.1, an effect of a sodium salt is limited and the polarizer is likely to suffer from yellowing. If the ratio of the sodium cation to the zinc cation exceeds 0.96, this can cause increased light transmittance changes, poor durability, and a reduced hybrid effect with the zinc cation. For example, the ratio of the sodium cation to the zinc cation may be in a range of 0.2 to 0.96, 0.3 to 0.96, 0.5 to 0.96, 0.6 to 0.96, 0.65 to 0.96, 0.8 to 0.96, or 0.85 to 0.96.

A total content of the sodium cation and the zinc cation in the polarizer is in a range from 500 ppm to 1,500 ppm. The inventors of the present invention confirmed that, even when the ratio of the sodium cation to the zinc cation in the polarizer is in a range from 0.1 to 0.96, the total content of the sodium cation and the zinc cation needs to be in the range of 500 ppm to 1,500 ppm to obtain all the desired effects of the present invention. If the total content of the sodium cation and the zinc cation is less than 500 ppm, the polarizing plate is likely to suffer from yellowing after being left at high temperature and an effect of addition of a metal salt is limited. If the total content of the sodium cation and the zinc cation exceeds 1,500 ppm, the polarizing plate can have poor appearance due to precipitation of zinc and sodium. For example, the total content of the sodium cation and the zinc cation may be in a range of 500 ppm to 1,300 ppm, 500 ppm to 1,200 ppm, 500 ppm to 1,000 ppm, 500 ppm to 950 ppm, or 500 ppm to 900 ppm.

In an embodiment, the content of the sodium cation in the polarizer may be in a range of 100 ppm to 1,000 ppm, for example, 200 ppm to 500 ppm, 200 ppm to 400 ppm, or 200 ppm to 300 ppm. Within this range, the polarizer can easily reach the ratio of the sodium cation to the zinc cation and the total content of the sodium cation to the zinc cation according to the present invention and can have high reliability at high temperature.

In an embodiment, the content of the zinc cation may be in a range of 200 ppm to less than 1,500 ppm, for example, 200 ppm to 1,000 ppm, 200 ppm to 900 ppm, 200 ppm to 700 ppm, 200 ppm to 600 ppm, 200 ppm to 500 ppm, or 200 to 400 ppm. Within this range, the polarizer can easily reach the ratio of the sodium cation to the zinc cation and the total content of the sodium cation to the zinc cation according to the present invention and can have high reliability at high temperature.

In an embodiment, the sodium cation and the zinc cation may be present in a total amount of 8% or more, for example, 8%, 9%, 10%, 11%, 12%, 13%, 14%, 15%, 16%, 17%, 18%, 19%, or 20%, and, in an embodiment, 8% to 20%, or 10% to 20%, based on the total content of metal cations in the polarizer on a ppm basis. Within this range, the desired effects of the present invention can be achieved. Herein, the “metal cations” may refer to all cations derived from an alkali metal, an alkaline earth metal, a transition metal, a post-transition metal, and a metalloid contained in the polarizer, respectively.

At least one of the sodium cation and the zinc cation may be present on at least a portion of a surface of the polarizer, or may be present inside the polarizer. In an embodiment, at least one of the sodium cation and the zinc cation may be present inside the polarizer to ensure reliability of the polarizer over a prolonged period of time.

The sodium cation may be derived from a material introduced in a polarizer manufacturing process. For example, the sodium cation may be derived from at least one selected from among sodium sulfate (Na₂SO₄), sodium nitrate (NaNO₃), and sodium phosphate (NasPO₄). For example, the sodium cation may be derived from sodium sulfate, which facilitates the polarizer to reach the ratio of the sodium cation to the zinc cation and the total content of the sodium cation to the zinc cation according to the present invention.

The zinc cation may be derived from a material introduced in a polarizer manufacturing process. For example, the zinc cation may be derived from at least one selected from among zinc sulfate (ZnSO₄), zinc chloride (ZnCl₂), zinc iodide (ZnI₂), zinc nitrate (Zn(NO₃)₂), and zinc acetate (Zn(CH₃CO₂)₂). The zinc cation may be derived from zinc sulfate, which facilitates the polarizer to reach the ratio of the sodium cation to the zinc cation and the total content of the sodium cation to the zinc cation according to the present invention.

The polarizer may further contain a potassium cation (K⁺). The potassium cation can assist in further increasing reliability of the polarizer at high temperature. The potassium cation and the sodium cation are both an alkali metal cation, and can allow each of the desired effects of the present invention to be achieved when present in an appropriate ratio in the polarizer.

In an embodiment, a ratio of the sodium cation to the potassium cation may be in a range of 0.02 to 0.15, for example, 0.03 to 0.10, 0.05 to 0.10, 0.05 to 0.09, or 0.05 to 0.08. Within this range, the effects of the present invention can be easily achieved. Herein, the “ratio” is a value calculated based on the weight of each of the sodium cation and the potassium cation in the polarizer, as measured by the method described above (for example, ICP-OES).

In an embodiment, a total content of the potassium cation and the sodium cation may be in a range of 3,000 ppm to 10,000 ppm, for example, 3,000 ppm, 4,000 ppm, 5,000 ppm, 6,000 ppm, 7,000 ppm, 8,000 ppm, 9,000 ppm, 10,000 ppm, for example, 3,000 ppm to 8,000 ppm, or 4,000 ppm to 6,000 ppm. Within this range, the effects of the present invention can be easily achieved.

In an embodiment, a ratio of the sum of the sodium cation and the zinc cation to the potassium cation may be in a range of 0.1 to 0.2, for example, 0.1, 0.11, 0.12, 0.13, 0.14, 0.15, 0.16, 0.17, 0.18, 0.19, 0.2, for example, 0.1 to less than 0.2, or 0.1 to 0.15. Within this range, the desired effects of the present invention can be easily achieved. Herein, the “ratio” is a value calculated based on the weight of each of the sodium cation, the zinc cation, and the potassium cation in the polarizer, as measured by the method described above (for example, ICP-OES).

In an embodiment, the sodium cation, the zinc cation, and the potassium cation may be present in an amount of 90% or more, for example, 90%, 91%, 92%, 93%, 94%, 95%, 96%, 97%, 98%, 99%, or 100%, and, in an embodiment, 95% to 100%, based on the total content of metal cations contained in the polarizer on a ppm basis. Within this range, the desired effects of the present invention can be achieved. Herein, the “metal cations” may refer to all cations derived from an alkali metal, an alkaline earth metal, a transition metal, a post-transition metal, and a metalloid, respectively.

The polarizer may further contain boron. Boron may be present in an appropriate amount relative to the sodium cation in the polarizer to assist in achieving the desired effects of the present invention.

In an embodiment, a ratio of the sodium cation (Na⁺) to a boron cation (B³⁺) may be in a range of 0.01 to 0.10, for example, 0.01 to 0.03. Within this range, the desired effects of the present invention can be easily achieved. Herein, the “ratio (Na⁺/B³⁺)” is a value calculated based on the weight of each of the sodium cation and the boron cation in the polarizer, as measured by the method described above.

In an embodiment, a total content of the boron cation and the sodium cation may be in a range of 15,000 ppm to 30,000 ppm, for example, 20,000 ppm to 25,000 ppm. Within this range, the desired effects of the present invention can be easily achieved.

In an embodiment, a content of the boron cation a(B³⁺) in the polarizer may be 10,000 to 30,000 ppm, for example, 20,000 to 25,000 ppm. Within this range, the desired effects of the present invention can be easily achieved.

In an embodiment, the polarizer may have a thickness of 30 μm or less, or 20 μm or less, for example, greater than 0 μm to 30 μm, or, for example, 10 μm to 25 μm. Within this range, the polarizer can be used in the polarizing plate.

In the following, a method of manufacturing the polarizer will be described in further detail.

The polarizer may be manufactured by a method including a dyeing process, a stretching process, a crosslinking process, and a color correction process. In an embodiment, the polarizer may be manufactured by sequentially performing the dyeing process, the stretching process, the crosslinking processes, and the color correction process. In another embodiment, the stretching process may be performed before the dyeing process. In another embodiment, the crosslinking process may be performed before the stretching process.

In embodiments of the present invention, the sodium cation and the zinc cation may be derived from materials used in the dyeing process, the stretching process, the crosslinking process, or the color correction process in the method. In an embodiment, the sodium cation and the zinc cation are derived from materials used in the color correction process in the method. The contents of the sodium cation and the zinc cation in the polarizer and the ratio therebetween may be implemented by adjusting the amount of materials used in the color correction process and/or in the overall polarizer manufacturing process.

### Dyeing Process

The dyeing process includes treatment of a polyvinyl alcohol based film in a dyeing bath containing a dichroic material. In the dyeing process, the polyvinyl alcohol based film is dipped in the dyeing bath containing the dichroic material. The dyeing bath containing the dichroic material includes an aqueous solution containing the dichroic material and boron compound. As the dyeing bath includes both the dichroic material and a boron compound, the dyed polyvinyl alcohol based film can be prevented or substantially prevented from fracture when stretched under the stretching conditions described below.

In an embodiment, the dichroic material is iodine and may include at least one selected from among potassium iodide, hydrogen iodide, lithium iodide, sodium iodide, zinc iodide, aluminum iodide, lead iodide, and copper iodide. In an embodiment, the dichroic material may be present in an amount of 0.5 mol/ml to 10 mol/ml, for example, 0.5 mol/ml to 5 mol/ml, in the dyeing bath, and, in an embodiment, in the dyeing solution. Within this range, uniform dyeing can be achieved.

The boron compound can assist in prevention of melting and fracture of the polyvinyl alcohol film upon stretching of the polyvinyl alcohol film. The boron compound can assist in prevention of melting and fracture of the polyvinyl alcohol based film in the subsequent stretching process even when the polyvinyl alcohol based film is stretched at high temperature and high stretching ratio.

The boron compound may include at least one selected from among boric acid and borax. In an embodiment, the boron compound may be present in an amount of 0.1 wt % to 5 wt %, and, in an embodiment, 0.3 wt % to 3 wt %, in the dyeing bath, and, in an embodiment, in the dyeing solution. Within this range, the polyvinyl alcohol based film does not suffer from melting and fracture in the stretching process and can achieve high reliability.

In an embodiment, the dyeing solution may have a temperature of 20° C. to 50° C., and, in an embodiment, 25° C. to 40° C. The dyeing process may be performed by dipping the polyvinyl alcohol based film in the dyeing bath for 30 seconds to 120 seconds, and, in an embodiment, 40 seconds to 80 seconds.

### Stretching Process

The stretching process includes stretching the dyed polyvinyl alcohol based film at a stretching ratio of at least 5.7 times, for example, 6 times to 7 times, at a temperature of 57° C. or more, for example, at 57° C. to 65° C. For a typical polyvinyl alcohol based film, stretching at the stretching ratio and the temperature results in failure to manufacture a polarizer due to melting and/or fracture of the polyvinyl alcohol based film.

The stretching process is performed by either wet stretching or dry stretching. In an embodiment, the stretching process includes wet stretching in order to apply the boron compound in the stretching process. Wet stretching includes uniaxial stretching of the polyvinyl alcohol based film in the machine direction in an aqueous solution containing a boron compound.

The boron compound may include at least one selected from among boric acid and borax. In an embodiment, the boron compound may be present in an amount of 0.5 wt % to 10 wt %, and, in an embodiment, 1 wt % to 5 wt %, in a stretching bath, and, in an embodiment, in the stretching solution. Within this range, the polyvinyl alcohol based film does not suffer from melting and fracture in the stretching process and can achieve high reliability.

### Crosslinking Process

The crosslinking process is performed to enhance adsorption of the dichroic material to the stretched polyvinyl alcohol based film. A crosslinking solution used in the crosslinking process includes a boron compound. The boron compound can assist in enhanced adsorption of the dichroic material described above while improving reliability of the polarizer even when the polarizer is left under a thermal shock condition.

The boron compound may include at least one selected from among boric acid and borax. In an embodiment, the boron compound may be present in an amount of 0.5 wt % to 10 wt %, and, in an embodiment, 1 wt % to 5 wt %, in a crosslinking bath, and, in an embodiment, in the crosslinking solution. Within this range, the polyvinyl alcohol based film does not suffer from melting and fracture in the stretching process and can achieve high reliability. The crosslinking bath may have a temperature of 20° C. to 50° C., and, in an embodiment, 25° C. to 40° C. The crosslinking process may be performed by dipping the polyvinyl alcohol based film in the crosslinking bath for 30 seconds to 120 seconds, and, in an embodiment, for 40 seconds to 80 seconds.

### Color Correction Process

The color correction process improves durability of the polyvinyl alcohol based film and makes it easy to achieve the ratio of the sodium cation to the zinc cation and the total content of the sodium cation to the zinc cation according to the present invention.

The color correction process may be performed by dipping and leaving the polyvinyl alcohol based film in a color correction bath. The color correction bath may contain a source of the sodium cation and a source of the zinc cation. As a result, the sodium cation and the zinc cation may be introduced into the polarizer in the same process during manufacture of the polarizer.

The source of the sodium cation may include at least one selected from among sodium sulfate, sodium nitrate, and sodium phosphate. In an embodiment, the sodium cation is derived from sodium sulfate, which makes it easy to achieve the ratio of the sodium cation to the zinc cation and the total content of the sodium cation to the zinc cation according to the present invention.

The source of the zinc cation may include at least one selected from among zinc sulfate, zinc chloride, zinc iodide, zinc nitrate, and zinc acetate. In an embodiment, the zinc cation is derived from zinc sulfate, which makes it easy to achieve the ratio of the sodium cation to the zinc cation and the total content of the sodium cation to the zinc cation according to the present invention.

In an embodiment, the source of the sodium cation may be present in an amount of 0.01 wt % to 5 wt %, for example, 0.02 wt % to 3 wt %, in the color correction bath. Within this range, the polyvinyl alcohol based film can easily form the polarizer according to the present invention.

In an embodiment, the source of the zinc cation may be present in an amount of 0.01 wt % to 5 wt %, for example, 0.02 wt % to 3 wt %, in the color correction bath. Within this range, the polyvinyl alcohol based film can easily form the polarizer according to the present invention.

The color correction bath may further contain potassium iodide. Potassium iodide may be present in an amount of greater than 0 wt % to 10 wt %, and, in an embodiment, 1 wt % to 5 wt %, in the color correction bath. Within this range, the polyvinyl alcohol based film can easily form the polarizer according to the present invention.

The polyvinyl alcohol based film may be subjected to a washing process and/or a swelling process before the dyeing process.

In the washing process, the polyvinyl alcohol based film is washed with water to remove foreign matter from the polyvinyl alcohol based film.

In the swelling process, the polyvinyl alcohol based film is dipped in a swelling bath in a certain temperature range (e.g., a predetermined temperature range) to facilitate dyeing with the dichroic material and stretching. In an embodiment, the swelling process may be performed at 15° C. to 35° C., and, in an embodiment, at 20° C. to 30° C., for 30 seconds to 50 seconds.

As the polarizing plate according to the present invention includes the polarizer described above, the polarizing plate can have high reliability at high temperature due to no yellowing and small variations in both color value as and color value bs after being left at high temperature with a typical protective film for polarizers alone without requiring an additional discoloration suppression layer and the like.

Referring to FIG. 1, a polarizing plate according to an embodiment of the present invention may include a polarizer 10, a first protective layer 20 formed on a surface of the polarizer 10, and a second protective layer 30 formed on another surface of the polarizer 10.

Referring to FIG. 2, a polarizing plate according to another embodiment of the present invention may include a polarizer 10, a first protective layer 20 formed on a surface of the polarizer 10 via a first bonding layer 40, and a second protective layer 30 formed on another surface of the polarizer 10 via a second bonding layer 50.

The polarizer 10 is substantially the same as described above.

### First Protective Layer 20 and Second Protective Layer 30

The first protective layer 20 may be formed on an upper surface of the polarizer 10 to protect the polarizer 10 and increase mechanical strength of the polarizing plate. The first protective layer 20 may include an optically clear protective film.

The protective film may be formed by melting and extrusion of a composition for the protective film including at least one organic component selected from among an optically clear resin, an optically clear oligomer, and an optically clear monomer. The protective film may further be subjected to stretching, as needed. The organic component may include at least one selected from among cellulose ester based resins including triacetylcellulose and the like, cyclic polyolefin based resins including an amorphous cyclic olefin polymer (COP) and the like, polycarbonate based resins, polyester based resins including polyethylene terephthalate (PET) and the like, polyethersulfone based resins, polysulfone based resins, polyamide based resins, polyimide based resins, non-cyclic polyolefin based resins, polyacrylate based resins including polymethyl methacrylate and the like, polyvinyl alcohol based resins, polyvinyl chloride based resins, and polyvinylidene chloride based resins.

In an embodiment, the protective layer may be a monolayer film or a multilayer film stack.

In an embodiment, the protective layer may be formed of a composition including more than 95 wt % of the organic component.

In an embodiment, the first protective layer 20 may have a thickness of 5 μm to 200 μm, and, in an embodiment, 10 μm to 100 μm, and, in an embodiment, 60 μm to 100 μm. Within this range, the first protective layer can be used in the polarizing plate.

A functional coating layer, such as a hard coating layer, an anti-fingerprint layer, and an antireflection layer, may be further formed on an upper surface of the first protective layer.

The second protective layer 30 may be formed on a lower surface of the polarizer 10 to protect the polarizer 10 and increase mechanical strength of the polarizing plate. The second protective layer 30 may include a film formed of the same resin as the first protective layer 20 or a different resin than the first protective layer 20.

In an embodiment, when the first protective layer 20 is a polyester based resin film, such as polyethylene terephthalate (PET), the second protective layer 30 may be a cyclic polyolefin based resin film, such as an amorphous cyclic olefin polymer (COP), or may be a cellulose ester based resin film, such as triacetylcellulose.

In another embodiment, when the first protective layer 20 is a cellulose ester based resin film, such as triacetylcellulose, the second protective layer 30 may be a cellulose ester based resin film, such as triacetylcellulose.

The second protective layer 30 may have the same thickness as the first protective layer 20, or may have a different thickness than the first protective layer 20.

As shown in FIG. 1, each of the first protective layer 20 and the second protective layer 30 may be directly formed (for example, coated, applied, or cured) on the polarizer 10. In another embodiment, the first protective layer 20 and the second protective layer 30 may be formed on the polarizer 10 via the first adhesive layer 40 and the second adhesive layer 50, respectively, as shown in FIG. 2.

Each of the first adhesive layer 40 and the second adhesive layer 50 may be formed of a typical bonding agent for polarizing plates known to those skilled in the art. For example, each of the first adhesive layer 40 and the second adhesive layer 50 may be formed of a water-based bonding agent or a photocurable bonding agent.

The water-based bonding agent may be any of a polyvinyl alcohol-based bonding resin, a crosslinking agent, and the like.

The photocurable bonding agent may include: at least one selected from among an epoxy compound and a (meth)acrylic compound; and an initiator. The initiator may include at least one selected from among a photo-radical initiator and a photo-cationic initiator, and, in an embodiment, a mixture thereof. The photocurable bonding agent may further include a typical additive such as an antioxidant and a pigment.

In an embodiment, each of the first adhesive layer 40 and the second adhesive layer 50 may have a thickness of 0.05 μm to 10 μm. Within this range, the first adhesive layer 40 and the second adhesive layer 50 can be used in an optical display apparatus.

In the following, an optical display apparatus according to an embodiment will be described.

An optical display apparatus according to one or more embodiments of the present invention includes the polarizing plate according to an embodiment of the present invention.

The optical display apparatus may include at least one selected from among a liquid crystal display and a light emitting display.

The light emitting display includes an organic light emitting device or an organic-inorganic hybrid light emitting device as a light emitting device. Here, the light emitting device may mean a light emitting diode (LED), an organic light emitting diode (OLED), a quantum dot light emitting diode (QLED), or a device including a light emitting material, such as phosphors and the like. The light emitting display may include the light emitting device and a polarizing plate on a light exit surface of the light emitting device, wherein the polarizing plate may include the polarizing plate according to an embodiment of the present invention.

The liquid crystal display may include a backlight unit, a liquid crystal panel, a light source-side polarizing plate between the backlight unit and a surface of the liquid crystal panel, and a viewer-side polarizing plate on another surface of the liquid crystal panel, wherein at least one of the light source-side polarizing plate and the viewer-side polarizing plate may include the polarizing plate according to an embodiment of the present invention.

Next, the present invention will be described in further detail with reference to some examples. However, it is to be understood that these examples are provided for illustration and are not to be construed in any way as limiting the present invention.

### Example 1

### 1. Manufacture of Polarizer

A polyvinyl alcohol based film (TS-#4500, containing a hydrophobic functional group on a main chain thereof, thickness: 45 μm, Kuraray Co., Ltd.) washed with water having a temperature of 25° C. was subjected to swelling treatment with water having a temperature of 30° C. in a swelling bath.

After swelling treatment, the film was dipped in a dyeing bath, which contained an aqueous solution containing 1 mol/ml of potassium iodide and 1 wt % of boric acid and having a temperature of 30° C. for 65 seconds. After dyeing treatment, the film was uniaxially stretched to 6 times in the MD in a wet stretching bath containing a 3 wt % aqueous solution of boric acid and having a temperature of 60° C. The stretched film was treated in a crosslinking bath containing a 3 wt % aqueous solution of boric acid and having a temperature of 25° C. for 65 seconds.

After crosslinking treatment, the film was dipped in a color correction bath containing an aqueous color correction solution containing 5 wt % of potassium iodide (KI), 0.5 wt % of sodium sulfate (Na₂SO₄), and 1.0 wt % of zinc sulfate (ZnSO₄) and having a temperature of 30° C. for 10 seconds, followed by washing and drying, thereby manufacturing a polarizer (thickness: 20 μm).

### 2. Manufacture of Polarizing Plate

A water-based bonding agent (containing polyvinyl alcohol-based bonding resin) was applied to both surfaces of the prepared polarizer, followed by attaching a polyethylene terephthalate (PET) film (thickness: 80 μm, Toyobo Co., Ltd.) and a triacetylcellulose (TAC) film (thickness: 40 μm, Konica Minolta Co., Ltd.) to upper and lower surfaces of the polarizer, respectively, thereby manufacturing a polarizing plate.

### Examples 2 and 3

Polarizers and polarizing plates were manufactured in the same manner as in Example 1 except that the content of each component in the dyeing bath, the stretching bath, and the crosslinking bath was changed and the concentration of each component in the color correction bath was changed.

### Comparative Example 1

A polarizer and a polarizing plate were manufactured in the same manner as in Example 1 except that, in the color correction process, the film was treated in a color correction bath, which contained an aqueous color correction solution containing 5 wt % of potassium iodide, 0 wt % of sodium sulfate, and 0 wt % of zinc sulfate and having a temperature of 30° C. for 10 seconds.

### Comparative Examples 2 to 7

Polarizers and polarizing plates were manufactured in the same manner as in Example 1 except that the content of each component in the dyeing bath, the stretching bath, and the crosslinking bath was changed together with the concentration of each component in the color correction bath.

Each of the polarizing plates of the Examples and Comparative Examples was evaluated as to the properties shown in Table 1. Results are shown in Table 1.
1. Concentration of cations in polarizer (unit: ppm): Concentration of cations in each of the polarizers manufactured in the Examples and Comparative Examples was measured by an ICP-OES system (Agilent 5100 Series, Agilent Technologies Inc.).
2. Variation in color value as and color value bs: Each of the polarizing plates manufactured in the Examples and Comparative Examples was cut to a size of 3 cm×3 cm (MD×TD of polarizer) and then adhesively bonded to a glass plate using an acrylic adhesive (SDI Ltd.), thereby preparing a specimen. Color value as and color value bs were measured on the prepared specimen using a spectrophotometer (V-7100, Jasco Corp.). Thereafter, the prepared specimen was left at 105° C. for 500 hours, followed by measurement of color value as and color value bs in the same manner as above. Variations in color value as and color value bs were calculated according to Equations 1 and 2, respectively.
3. Variation in polarization degree (unit: %): Each of the polarizing plates manufactured in the Examples and Comparative Examples was cut to a size of 3 cm×3 cm (MD×TD of polarizer) and then adhesively bonded to a glass plate using an acrylic adhesive (SDI Ltd.), thereby preparing a specimen. Polarization degree was measured on the prepared specimen using a spectrophotometer (V-7100, Jasco Corp.). Thereafter, the prepared specimen was left at 105° C. for 500 hours, followed by measurement of polarization degree in the same manner as above. A variation in polarization degree was calculated according to Equation 3.
4. Variation in light transmittance (unit: %): Each of the polarizing plates manufactured in the Examples and Comparative Examples was cut to a size of 3 cm×3 cm (MD×TD of polarizer) and then adhesively bonded to a glass plate using an acrylic adhesive (SDI Ltd.), thereby preparing a specimen. Light transmittance was measured on the prepared specimen using a spectrophotometer (V-7100, Jasco Corp.). Thereafter, the prepared specimen was left at 105° C. for 500 hours, followed by measurement of light transmittance in the same manner as above. A variation in light transmittance was calculated according to Equation 4.
5. Yellowing: Each of the polarizing plates manufactured in the Examples and Comparative Examples was cut to a size of 10 cm×10 cm (MD×TD of polarizer), attached to a glass plate with or without a bonding agent, and left at 105° C. for 500 hours, followed by evaluation of yellowing with the naked eye. When yellowing was not observed, a corresponding polarizing plate was rated as “O” and, when yellowing was observed, a corresponding polarizing plate was rated as “X”.
6. Appearance (deposition): Each of the polarizers manufactured in the Examples and Comparative Examples was checked as to occurrence of deposition of a white material with the naked eye immediately after manufacture thereof. The white material was identified as zinc and sodium by ICP-OES. When deposition of the white material was not observed, a corresponding polarizer was rated as “O” and, when deposition of the white material was observed, a corresponding polarizer was rated as “X”.

TABLE 1

| | | Example | | | Comparative Example | | | | | | |
|---|---|---|---|---|---|---|---|---|---|---|---|
| | | 1 | 2 | 3 | 1 | 2 | 3 | 4 | 5 | 6 | 7 |
| Polarizer | Na⁺ | 384 | 250 | 279 | — | — | 426 | 14 | 21 | 184 | 266 |
| | Zn²⁺ | 558 | 290 | 292 | — | 1183 | — | 1899 | 528 | 1808 | 250 |
| | K⁺ | 4901 | 4253 | 4590 | 8708 | 6131 | 5165 | 6339 | 5125 | 6404 | 4368 |
| | Na⁺/Zn²⁺ | 0.688 | 0.862 | 0.955 | — | — | — | 0.007 | 0.040 | 0.102 | 1.064 |
| | Na⁺ + | 942 | 540 | 571 | — | 1183 | 426 | 1913 | 549 | 1992 | 516 |
| | Zn²⁺ | | | | | | | | | | |
| | Na⁺ + K⁺ + | 5843 | 4793 | 5161 | 8708 | 7314 | 5591 | 8252 | 5674 | 8396 | 4884 |
| | Zn²⁺ | | | | | | | | | | |

| | | | | | | | | | | |
|---|---|---|---|---|---|---|---|---|---|---|
| Variation in color | −1.2 | −0.9 | −0.9 | −1.5 | −1.4 | −1.3 | −1.2 | −1.3 | −1.2 | −1.4 |
| value as | | | | | | | | | | |
| Variation in color | 3.6 | 2.5 | 3 | 4 | 4.3 | 4.6 | 3.9 | 8.5 | 4 | 3.3 |
| value bs | | | | | | | | | | |
| Variation in | −0.04 | −0.02 | −0.01 | −0.16 | −0.06 | −0.06 | −0.04 | −0.04 | −0.04 | −0.02 |
| polarization degree | | | | | | | | | | |
| Variation in light | 0.3 | 0.4 | 0.3 | 0.7 | 0.6 | −0.04 | 0.1 | −0.9 | 0.2 | 0.8 |
| transmittance | | | | | | | | | | |
| Yellowing | ◯ | ◯ | ◯ | X | ◯ | ◯ | X | X | ◯ | ◯ |
| Appearance | ◯ | ◯ | ◯ | ◯ | ◯ | ◯ | X | ◯ | X | ◯ |
| (deposition) | | | | | | | | | | |

* There was no influence of the glass plate and the acrylic adhesive on color value as, color value bs, polarization degree, and light transmittance.

As can be seen from Table 1, the polarizing plate according to the present invention did not suffer from precipitation of at least one of zinc and sodium from the polarizer and exhibited high reliability at high temperature due to no yellowing and small variations in color value as, color value bs, polarization degree, and light transmittance after being left at high temperature for a period of time.

By contrast, the polarizing plates of Comparative Example 4 and Comparative Example 6, in which the content of metal cations (the sum of a zinc cation and a sodium cation) in the polarizer was excessively high, suffered from precipitation of zinc and sodium from the polarizer. Although the polarizing plates of Comparative Examples 1 to 3, which did not contain at least one selected from among a zinc cation and a sodium cation, did not suffer from precipitation, these polarizing plates exhibited poor reliability at high temperature. Despite containing both a zinc cation and a sodium cation, the polarizing plates of Comparative Examples 4 to 7, which did not satisfy the contents of the zinc cation and the sodium cation and the ratio therebetween according to the present invention, exhibited poor reliability at high temperature.

Although some example embodiments have been described herein, it is to be understood that various modifications, changes, alterations, and equivalent embodiments can be made by those skilled in the art without departing from the spirit and scope of the invention.

What is claimed is:

1. A polarizing plate comprising:
a polarizer; and
a protective layer on at least one surface of the polarizer,
wherein the polarizer comprises a polyvinyl alcohol based film containing a dichroic material and contains a zinc cation and a sodium cation, and
wherein a ratio of the sodium cation to the zinc cation is in a range from 0.1 to 0.96, and a total content of the zinc cation and the sodium cation is in a range from 500 ppm to 1,500 ppm.

2. The polarizing plate as claimed in claim 1, wherein a content of the sodium cation in the polarizer is in a range from 100 ppm to 1,000 ppm, and a content of the zinc cation in the polarizer is in a range from 200 ppm to less than 1,500 ppm.

3. The polarizing plate as claimed in claim 1, wherein the sodium cation and the zinc cation are present in a total amount of 8% or more based on a total content of all metal cations in the polarizer on a ppm basis.

4. The polarizing plate as claimed in claim 1, wherein the sodium cation is derived from sodium sulfate (Na₂SO₄), and the zinc cation is derived from zinc sulfate (ZnSO₄).

5. The polarizing plate as claimed in claim 1, wherein the polarizer further contains a potassium cation.

6. The polarizing plate as claimed in claim 5, wherein a ratio of the sodium cation to the potassium cation is in a range from 0.02 to 0.15.

7. The polarizing plate as claimed in claim 5, wherein a total content of the potassium cation and the sodium cation is in a range from 3,000 to 10,000 ppm.

8. The polarizing plate as claimed in claim 5, wherein a ratio of a sum of the sodium cation and the zinc cation to the potassium cation is in a range from 0.1 to 0.2.

9. The polarizing plate as claimed in claim 5, wherein the sodium cation, the zinc cation, and the potassium cation are present in a total amount of 90% based on a total content of all metal cations in the polarizer on a ppm basis.

10. The polarizing plate as claimed in claim 5, wherein the polarizer further contains a boron cation.

11. The polarizing plate as claimed in claim 1, wherein the polyvinyl alcohol based film contains both a hydrophilic functional group and a hydrophobic functional group.

12. The polarizing plate as claimed in claim 1, wherein the protective layer is on an outermost side of the polarizing plate.

13. The polarizing plate as claimed in claim 12, wherein the protective layer is formed of a composition comprising more than 95 wt % of an organic component.

14. The polarizing plate as claimed in claim 13, wherein the organic component comprises at least one selected from among a resin, an oligomer, and a monomer.

15. An optical display apparatus comprising the polarizing plate as claimed in claim 1.
